(19) United States
(12) Patent Application Publication
(10) Pub. No.: US 2008/0201185 A1
(43) Pub. Date: Aug. 21, 2008

(54) METHOD FOR COMBINING MAIL PIECES THAT WERE GOING TO BE MAILED ON DIFFERENT DATES TO INCREASE POSTAL DISCOUNTS

(75) Inventors: John H. Winkelman, Southbury, CT (US); Carlos Reyes, East Haven, CT (US); Qiuju Gu, Milford, CT (US); John W. Rojas, Norwalk, CT (US); Kenneth G. Miller, Washington, DC (US)

Correspondence Address: PITNEY BOWES INC.;35 WATERVIEW DRIVE, P.O. BOX 3000, MSC 26-22, SHELTON, CT, 06484-8000, US

(73) Assignee: PITNEY BOWES INC., Stamford, CT (US)

(21) Appl. No.: 12/028,386

(22) Filed: Feb. 8, 2008

Related U.S. Application Data
(60) Provisional application No. 60/901,167, filed on Feb. 13, 2007.

(51) Int. Cl. G06Q 10/00

(52) U.S. Cl. 705/7

(57) ABSTRACT

A method for obtaining mail discounts by determining a date a mail piece should be mailed and adjusting the date the mail piece is mailed to fill one or more mailing trays with mail pieces that were originally planned to be mailed on different dates to obtain postal discounts

This application claims the benefit of the filing date of U.S. Provisional Application No. 60/901,167 filed Feb. 13, 2007, which is owned by the assignee of the present Application.

### FIELD OF THE INVENTION

This invention relates to mailing mail pieces and, more specifically, to mailing and sorting mail pieces to increase postal discounts.

### BACKGROUND OF THE INVENTION

Most companies throughout the United States use the services of the United States Postal Service (USPS) to communicate with their customers. These companies use the USPS to deliver monthly bills, monthly statements, and annual reports for shareholders, catalogs for holiday shopping, newspapers, monthly magazine subscriptions, and Standard Mail (A) direct mail.

The cost associated with moving mail from the sender to the recipient is related primarily to the manual effort involved. The mail must go through several sorting processes and eventually be sorted down to the carrier delivering the mail.

The USPS has issued approximately 42,000 five digit zip codes in order to improve the automatic sortation and delivery of mail. If mail pieces are pre-sorted by large mailers it becomes easier for the USPS to process the mail.

The USPS has spent billions of dollars to automate this process. The intent of automation is to process the mail faster while minimizing costs. To minimize costs, automated equipment has been manufactured and data processing methods have been implemented. The data processing methods were created so that the mailers themselves could perform certain tasks that would make it easier for the USPS to process the mail. The USPS passes the labor savings on to any mailer who shares in the work in the form of postage discounts. This is known as “work sharing.” There are a number of tasks that a mailer can perform to obtain work sharing discounts. The more work the mailer performs, the greater the discounts.

The USPS offers work share discounts for mailings that meet certain address, barcode and sortation standards so as to allow the mailing to bypass certain processing steps and expedite the mailing process. These special discounts are called ‘workshare’ discounts. Mailings that meet ‘workshare’ standards qualify for discount ‘automation’ rates (5-digit/scheme, 3-digit/scheme, AADC (Automated Area Distribution Centers), Mixed AADC). For example, to qualify for the 5-digit/scheme rate, a tray with a minimum of 150 pieces must be destined to the same 5-digit zip code (e.g., 06512). Under current USPS postal Regulations there are other instances where a 5 digit scheme discount may be obtained by combining zip codes in the same geographic vicinity, e.g. all the following zip codes may be combined with zip code 53707: 53708, 53774, 53777, 53778, 53779, 53782, 53783, 53784, 53785, 53786, 53788, 53789, 53790, 53791, 53792, 53793, and 53794 to obtain the 5-digit/scheme rate.

To qualify for the 3-digit/scheme rate, a tray with a minimum of 150 pieces must be destined to the same 3-digit zip code 068XX (Stamford, Conn.), 120XX (Albany, N.Y.), 191XX (Philadelphia, Pa.), 465XX (South Bend, Ind.) and to qualify for the AADC rate a tray with a minimum of 150 pieces must be destined to the same AADC. To qualify for mixed AADC all remaining pieces placed in trays are required to be mixed AADC.

The following rates and fees apply to one-ounce First Class automation letters:

| | |
|---|---|
| 5-digit/scheme | $0.293 |
| 3-digit/scheme | $0.308 |
| AADC | $0.317 |
| Mixed AADC | $0.326 |

Consequently, mailers use file-based presort software and/or physical presort to maximize their mailings 5-digit sortation densities for workshare discounts. Furthermore, these mailers are producing and inducting large volumes of mail several days a month or even daily as it is the case for large billers (e.g., credit card billers). However, although they are sending large volumes of mail to the same 5-digit/scheme (throughout the month), they usually cannot take advantage of 5-digit/scheme rates because they do not meet the minimum required pieces per tray on a given day. This problem is costing large mailer a lot of money. For example, a large credit card biller with monthly volumes close to 18 million mail pieces has only a natural 5-digit/scheme sortation density of about 26% since they are producing and sending their bills according to their customers billing cycles and payment due dates.

A disadvantage of the prior art is that many large mailers were not able to take advantage of postal discounts.

A further disadvantage of the prior art is that some times large mailers just fall short by a few mail pieces of filling a portion of a tray or container able to take advantage of higher postal discounts.

### SUMMARY OF THE INVENTION

This invention overcomes the disadvantages of the prior art by utilizing a method that enables mailers to obtain additional postal discounts. The foregoing is accomplished by enabling the mailer to place additional mail pieces in mail trays or mail containers so that there will be sufficient mail pieces in the mail trays or mail containers to obtain postal discounts.

This invention increases 5-digit and 3-digit sortation densities across mailings having different document production or billing cycles. This is accomplished by moving credit card holder recipients' billing cycles or mailing dates in mailing runs to optimal production dates for USPS postal workshare discounts while complying with statutory limits for changing billing cycles dates (e.g., up to +/−4 days for credit card customers). The foregoing may also be used for other types of mailings, i.e., insurance premium notices, other types of bills, notice documents required by law, marketing mailings, etc.

### BRIEF DESCRIPTION OF THE DRAWINGS

FIG. 1 is a block diagram of this invention;

FIG. 2 is a flow chart of an algorithm for adjusting the date a mail piece should be mailed to increase postal discounts;

FIG. 3 is a graph of an example of mail pieces sent to a single five digit zip code before utilizing the process of this invention;

FIG. 4 is a table of the monthly sortation density for the sample for the five digit scheme destination zip code for the graph shown in FIG. 3;

FIG. 5 is a graph of an example of mail pieces sent to a single five digit zip code after utilizing the process of this invention; and

FIG. 6 is a table of the monthly sortation density for the sample for the five digit scheme destination zip code for the graph shown in FIG. 5.

### DETAILED DESCRIPTION OF THE INVENTION

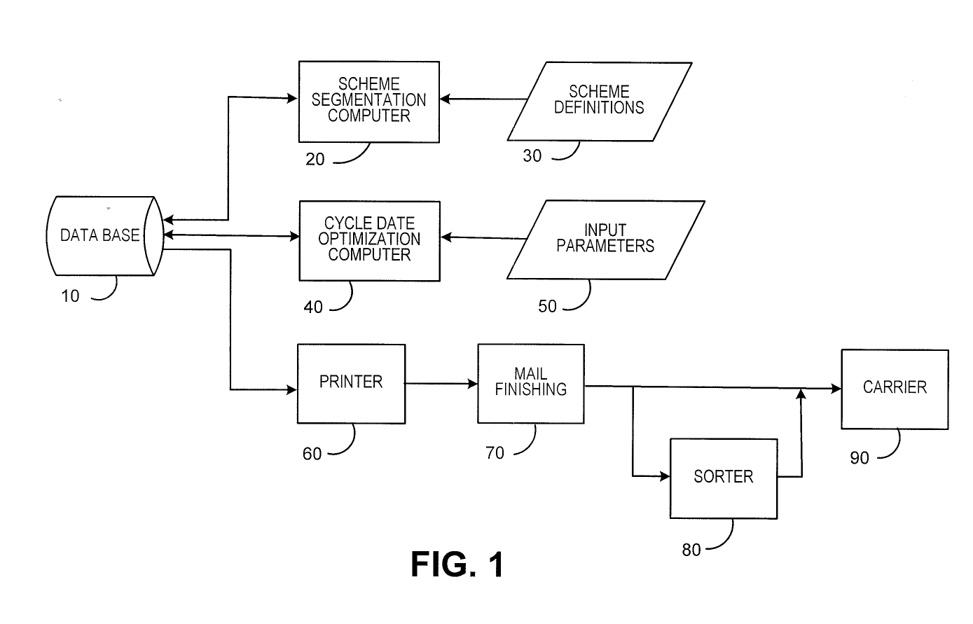

Referring now to the drawings in detail and, more particularly, to FIG. 1, the reference character 10 represents a data base that contains customer addresses including five digit zip codes for the customers of a mailer. Data base 10 also contains the customer's document production or billing cycle that is used to determine what customer data is going to be extracted at a particular time to print a document or bill that is going to be mailed on a specific day of the month. Data base 10 may also contain the aforementioned information for more than one mailer. Data base 10 or another database (not shown) may contain the information required to produce the documents that are going to be mailed.

The customer documents or bills contained in Data base 10 are initially divided into schemes by Scheme Segmentation Computer 20 using the scheme definitions from Scheme Definitions Database 30. For example, if the desired optimization is for 5-digit scheme, then Scheme Segmentation Computer 20 will combine customer documents or bills that are part of the same 5-digit scheme (i.e. all 5-digit zip codes that can be combined to qualify for the postal discount). The scheme groupings are then saved to Data base 10.

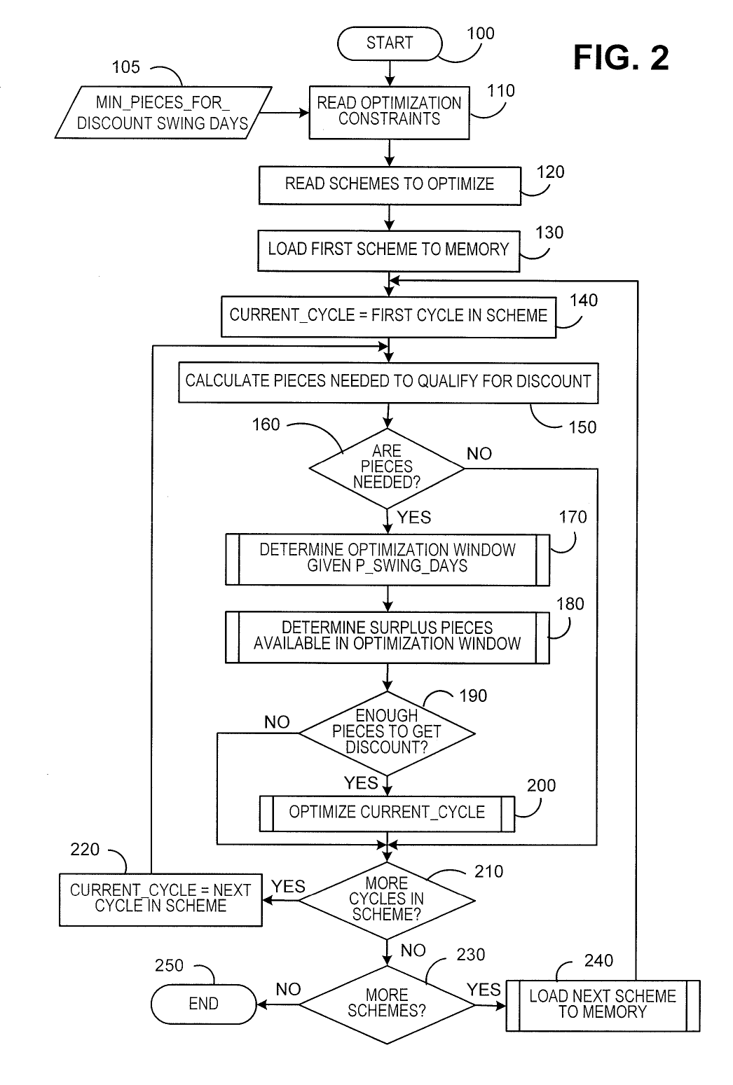

Data base 10 is coupled to Computer 40. Computer 40 queries data base 10 to extract all customer documents or bills that are to be printed, as grouped by Computer 20. A program contained in Computer 40, which is described in the description of FIG. 2 reorders the billing or document production cycle within a selected Date Range Constraints, received from Input Parameters 50 to maximize the zip code density of documents or bills across a selected range of billing or document cycles, to a quantity of documents or bills no lower than the minimum amount of documents or bills required for the discount also received from Input Parameters 50. In other words the mailer may change the billing cycle of documents or bills to obtain a postal discount. For example if 150 documents or bills in a tray with the same zip code are required to obtain a postal discount and the mailer only has 130 documents or bills having the same zip code in the tray, the mailer may obtain 20 additional documents or bills that are going to be mailed on another date, within the date range constraints, to fill the tray and obtain the postal discount. The input parameters 12 may be defined by a human, computer, legal regulation (the mailer may change the billing cycle of its customers by a specified number of days) and entered via any input device, i.e. keyboard, computer, data base, etc. Data base 10 is then updated with the optimized or reordered billing or document production cycle data from Computer 40. Some time after Computer 40 has completed reordering the mail, Printer 60 will read from Data base 10 document or bill printing and finishing data needed to print the documents and envelopes.

Then the printed documents and envelopes are sent to mail finishing equipment 70 where the documents are inserted into printed addressed envelopes or inserted into windowed envelopes and franked. The finished mail pieces are then placed in trays in zip code order and delivered to Carrier 90, i.e., USPS.

Alternatively some mailers may have their finished mail pieces physically presorted by Sorter 80 with other mailers mail before they are delivered to Carrier 90 to obtain even higher postal discounts.

FIG. 2 is a flow chart of an Cycle Date Optimization algorithm for adjusting the date when a mail piece should be mailed to increase postal discounts. The algorithm for cycle date optimization below will optimize any provided schemes, based on how they are segmented in the previous step, Scheme Segmentation Computer 20 (FIG. 1), using some desired optimization constraints as described below:

The process begins in Step 100 where the Cycle Date Optimization is started and follows to Step 110 where the Optimization Constraints, Minimum Mail Pieces for Discount and Swing Days, are read from Step 105. The process continues in Step 120 where the schemes to optimize are loaded and prepared for processing. Each scheme contains a set of documents or bills being optimized, i.e. documents or bills targeted to different zip codes, through a range of cycle days, first cycle to last cycle, that can be combined within the specified swing days to achieve a postal discount. Next in Step 130, the first scheme is loaded into memory for processing and in Step 140 the first cycle is loaded into memory. Each cycle contains all the documents or bills being mailed on the given cycle day to different zip codes that are part of the scheme.

Next in Step 150, the mail pieces needed to qualify for the discount are calculated as: PIECES_NEEDED=MIN_PIECES_FOR_DISCOUNT−CYCLE_PIECES. Then in Step 160, the process checks if more mail pieces are needed to qualify for the postal discount. If no more mail pieces are needed to qualify for the postal discount, the process continues to Step 210, where the next cycle will be processed. If more mail pieces are needed, the process continues to Step 170 where optimization window is calculated as follows:

OPTIMIZATION_WINDOW=CYCLE_DAY+/−SWING_DAYS, excluding current cycle day

Then in Step 180 the days in the optimization window are scanned for surplus mail pieces; i.e. for each day in the optimization window, select all mail pieces if that day does not qualify for the postal discount, or select only the extra mail pieces above minimum, if that day already qualifies for the postal discount. Next Step 190, checks if enough surplus mail pieces are available to obtain the discount for the current cycle. If the postal discount can be met, the process will continue with Step 200 where the cycle is optimized, otherwise, the process will skip Step 200 and continue with Step 210 instead.

In Step 200 the current cycle is optimized to meet the minimum mail piece count discount requirements by moving sufficient mail pieces from other cycle days within the optimization window to the current cycle, but never too many mail pieces so as to take the discount away from a different cycle day already meeting the discount. When sufficient pieces are moved to qualify for the discount, the process continues with Step 210.

In Step 210 if more cycles are available in the scheme, then in Step 220, the next cycle in the scheme is selected for processing and the process continues back to Step 150. If no more cycles are available in the scheme, the process continues with Step 230. In Step 230, if more schemes are available to process, then process continues with step 240, where the next scheme to process is loaded into memory, after which the process continues back to Step 140. If no more schemes need to be processed, the process ends in Step 250.

Additional postal discounts may be achieved by combining any remaining non-qualifying cycle days with other qualifying cycle days within the optimization window. Also, mail pieces from a cycle in a different month can be moved when pieces are needed to qualify for the discount. For example, cycle 31 in October could be used to optimize cycle 1 in November. Furthermore, optimization scenarios can be performed and compared for the best discounts, such as running the optimization in different sequence, i.e., last cycle to first cycle, middle cycle outwards, etc.

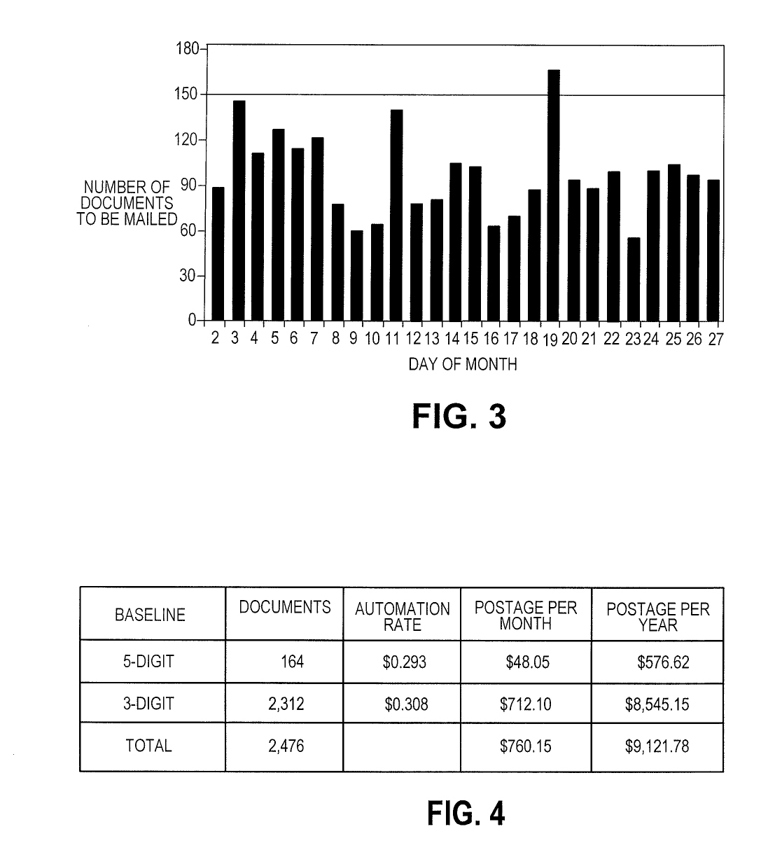

FIG. 3 is a graph of an example of mail pieces sent to a single five digit zip code before utilizing the process of this invention, where the x axis is the day of the month, or cycle day, and the y axis is the number of documents to be mailed. Since the USPS requires a minimum of 150 pieces going to the same 5-digit/scheme destination zip, only mail pieces in cycle 19 qualify for 5-digit/scheme rates.

FIG. 4 is a table of the monthly sortation density for the sample for the five digit scheme destination zip code for the graph shown in FIG. 3; The table shows a baseline of the corresponding monthly sortation densities for zip 06512 assuming all non 5-digit mail qualifies for 3-digit/scheme rates. The 5-digit row shows the mail corresponding to 5-digit discount while the 3-digit row shows the mail qualifying for 3-digit discount. The Documents column shows the total number of mail pieces; the Automation Rate column is the rate being charged per mail piece; the Postage per Month and Postage per Year columns show the total monthly and yearly postage costs assuming the same mailing volume, costs and discounts. The figure shows that under this arrangement, the yearly postage cost will be approximately $9,121.78.

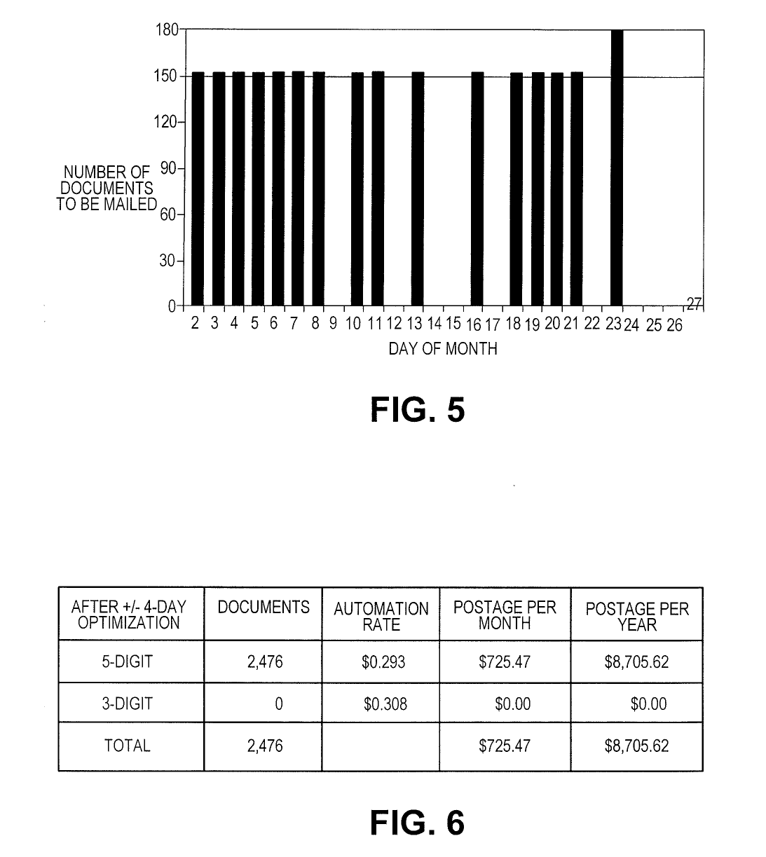

FIG. 5 is a graph of an example of the same mail pieces depicted in FIG. 4, after utilizing the process of this invention. In this case, all mail was optimized to 5-digit/scheme rate. However, this would not be the case for each 5-digit/scheme destination zip code: some pieces will remain 3-digit others will end up in AADC or Mixed AADC sortation categories. Therefore, additional optimization iterations can be done to optimize all remaining mail to 3-digit scheme, AADC, etc.

FIG. 6 is a table of the monthly sortation density for the sample for the five digit scheme destination zip code for the graph shown in FIG. 5. It is analogous to FIG. 4, in that it shows the number of pieces at each scheme rate and the monthly and yearly costs. What is most notable is that after optimization, the yearly costs go down from $9,121.78 in FIG. 4, to $8,705.62 as shown in FIG. 6.

The above specification describes a new and improved method that enables mailers to obtain additional postal discounts by adjusting the date mail pieces are going to be mailed to obtain additional postal discounts. It is realized that the above description may indicate to those skilled in the art additional ways in which the principles of this invention may be used without departing from the spirit. Therefore, it is intended that this invention be limited only by the scope of the appended claims.

What is claimed is:

1. A method for obtaining mail discounts, comprising the steps of:
determining a date a mail piece should be mailed;
adjusting the date the mail piece is mailed to fill one or more mailing trays with mail pieces that were originally planned to be mailed on different dates to obtain postal discounts.

2. The method claimed in claim 1, wherein the adjusting the date step further comprises the steps of:
changing cycle dates of the mail pieces that are going to be mailed to add additional mail pieces to one or more of the mailing trays to qualify for the postal discounts.

3. The method claimed in claim 2, wherein the cycle dates is the billing cycle for the mail piece.

4. The method claimed in claim 2, wherein the cycle dates are adjusted by an amount of days that conforms to regulations.

5. The method claimed in claim 1, wherein the adjusting the date step further comprises:
reordering the mail piece mailing date with a selected date range to maximize the zip code densities for mail pieces produced across a selected range of mailing cycles.

6. The method claimed in claim 1, wherein the postal discounts are obtained by sorting the mail pieces to a five digit zip code.

7. The method claimed in claim 1, wherein the postal discounts are obtained by sorting the mail pieces to a three digit zip code.

8. The method claimed in claim 1, wherein the postal discounts are obtained by sorting the mail pieces to Automated Area Distribution Centers.

9. A method for obtaining mail discounts, comprising the steps of:
determining how many mail pieces in a mail run are needed to obtain postal discounts;
adjusting production of the mail pieces in the mail run to optimize postal discounts.

10. The method claimed in claim 9, wherein the adjusting production step further comprises the steps of:
producing additional mail pieces to fill one or more mailing trays with mail pieces that were originally planned to be mailed on different dates to obtain postal discounts.

11. The method claimed in claim 10, wherein the producing step further comprises the steps of:
changing cycle dates of the mail pieces that are going to be mailed to add additional mail pieces to one or more of the mailing trays to qualify for the postal discounts.

12. The method claimed in claim 11, wherein the cycle dates is the billing cycle for the mail piece.

13. The method claimed in claim 11, wherein the cycle dates are adjusted by an amount of days that conforms to regulations.

14. The method claimed in claim 9, wherein the adjusting production step further comprises:
reordering the mail piece mailing date with a selected date range to maximize the zip code densities for mail pieces produced across a selected range of mailing cycles.

15. The method claimed in claim 9, wherein the postal discounts are obtained by sorting the mail pieces to a five digit zip code.

16. The method claimed in claim 9, wherein the postal discounts are obtained by sorting the mail pieces to a three digit zip code.

17. The method claimed in claim 9, wherein the postal discounts are obtained by sorting the mail pieces to Automated Area Distribution Centers.
